(19) United States
(12) Patent Application Publication
(10) Pub. No.: US 2026/0218013 A1
(43) Pub. Date: Jul. 30, 2026

(54) VAPOR BARRIER ELEMENT AND METHOD FOR USE THEREOF

(71) Applicant: Evolution Mechanical Products, LLC, Ridgefield, CT (US)

(72) Inventor: Michael S. Flynn, Ridgefield, CT (US)

(21) Appl. No.: 19/461,228

(22) Filed: Jan. 27, 2026

Related U.S. Application Data
(60) Provisional application No. 63/749,989, filed on Jan. 27, 2025.

(51) Int. Cl. C09J 7/29; C09J 5/00; C09J 7/30; C09J 7/40; F16L 58/16

(52) U.S. Cl. CPC C09J 7/29; C09J 5/00; C09J 7/30; C09J 7/403; F16L 58/16

(57) ABSTRACT

A vapor barrier element includes an hour-glass shape with a connecting portion connecting first and second tear drop shaped end parts made of a vapor barrier material, an adhesive layer provided on a surface thereof and a release layer including a first part and a second part operative to releasably cover the adhesive layer such that the first part and the second part are independently removable to expose the adhesive layer.

### CROSS-REFERENCE TO RELATED APPLICATIONS

The present application claims benefit of and priority to U.S. Provisional Patent Application Ser. No. 63/749,989 filed Jan. 27, 2025 entitled VAPOR BARRIER ELEMENT, the entire content of which is hereby incorporated by reference herein.

### BACKGROUND

### Field

The present application relates to a preformed vapor barrier element that may be used to provide vapor barrier protection for insulated pipe bends. In particular, the present application relates to a vapor barrier element including an adhesive that is used to wrap over the insulation on a pipe. The vapor barrier element has a predetermined shape suitable for providing coverage on a bent portion of a pipe and includes an adhesive layer that allows for direct application to the insulated pipe. The adhesive is covered by a two-piece release layer that protects the adhesive prior to application of the vapor barrier element to the insulation.

### Related Art

Construction and renovation of mechanical and plumbing systems in structures often requires installation, replacement or repair of pipes. These pipes serve various functions including water pipes, heating pipes and HVAC pipes. In many applications, the pipes are insulated, for example, heating pipes and water pipes which may carry fluids of different temperatures. Below ambient insulated pipes are required to have a vapor barrier to prevent moisture from affecting the insulation, preventing mold and maintaining the integrity of the insulation. Straight pipes may simply be wrapped along their length. Curved portions, fittings, tees, joints and junctions are not easily wrapped given the difference between the inner our outer portions of the circumference thereof.

For example, as can be seen in FIG. 1, an angle in a pipe has a relatively short circumference at the inner portion of the curve while the outer portion of the circumference is substantially larger. Further, the circumference changes between the inner portion and the outer portion. Thus, it is difficult to accurately cover the whole junction.

It is an object of the present disclosure to provide a vapor barrier element that avoids these and other problems.

### SUMMARY

A preconfigured vapor barrier element in accordance with an embodiment of the present disclosure is provided with a preconfigured shape and is configured to adequately cover an angled portion of the insulated pipe.

A vapor barrier element in accordance with an embodiment of the present disclosure includes: a vapor barrier layer having an hour-glass shape with a connecting portion connecting a first end part and a second end part; an adhesive layer provided on an inner surface of the vapor barrier layer; and a release layer releasably secured to the adhesive layer and including a first part and a second part, the first part and second part covering the adhesive layer such that the first part is separable from the adhesive layer independent of the second part.

In embodiments, the vapor barrier layer includes polyester film, aluminum foil and another polyester film layer.

In embodiments, the vapor barrier layer includes one or more of saran, polyethylene, rubberized asphalt, aluminum foil, extruded polystyrene or a foil-faced foam, membranes, paper-backed aluminum, elastomeric coatings, asphalt covered kraft paper, metallized film, a ply-aluminum foil-poly sheet, and poly-vinylidene chloride, to name a few.

In embodiments, the adhesive layer includes a substrate with an adhesive material provided on a surface opposite the vapor barrier layer.

In embodiments, the adhesive material includes a cold weather acrylic adhesive.

In embodiments, the adhesive layer includes an adhesive material provided on a surface of the vapor barrier layer.

In embodiments, the release layer includes a seam provided between the first part and the second part and positioned over the connecting portion of the vapor barrier layer.

In embodiments, the connecting portion is narrower in width than the first end part and the second end part of the vapor barrier layer.

A method of applying a vapor barrier element in accordance with an embodiment of the present disclosure includes steps of: partially releasing a first part of a release layer of the vapor barrier element to expose a first portion of an adhesive layer of the vapor barrier element provided over a connecting portion of a vapor barrier layer of the vapor barrier element; securing the exposed first portion of the adhesive layer and the connecting portion to the inner curved portion of the curved portion of the insulated pipe; gradually removing a remainder of the first part of the release layer to expose a second portion of the adhesive layer provided over a first end part of the vapor barrier layer; securing the second portion of the adhesive layer and the second end part of the vapor barrier layer to the insulated pipe such that the first end part is secured to the outer curve of the curved portion of insulated pipe; partially releasing a second part of the release layer of the vapor barrier element to expose a third portion of the adhesive layer over the connection portion of the vapor barrier layer; securing the exposed third portion of the adhesive layer to the inner curved portion of the curved portion of insulated pipe; gradually removing a remainder of the second part of the release layer to expose a fourth portion of the adhesive layer provided over a second end part of the vapor barrier layer; and securing the fourth portion of the adhesive layer and the second end part of the vapor barrier layer to the insulated pipe such that the second end part of the vapor barrier layer is secured to the outer curve of the curved portion of insulated pipe.

In embodiments, the connecting portion, first end part and second end part of the vapor barrier layer form an hour-glass shape.

In embodiments, the release layer comprises a seam separating the first part and the second part.

In embodiments, the seam is positioned over the connecting portion of the vapor barrier layer.

In embodiments, the vapor barrier layer includes polyester film, aluminum foil and another polyester film layer.

In embodiments, the vapor barrier layer includes at least one of the group consisting of: saran, polyethylene, rubberized asphalt, aluminum foil, extruded polystyrene or a foil-faced foam, membranes, paper-backed aluminum, elastomeric coatings, asphalt covered kraft paper, metallized film, a ply-aluminum foil-poly sheet, and poly-vinylidene chloride.

In embodiments, the adhesive layer includes a substrate with an adhesive material provided on a surface opposite the vapor barrier layer.

In embodiments, the adhesive material includes a cold weather acrylic adhesive.

In embodiments, the adhesive layer includes an adhesive material provided on a surface of the vapor barrier layer.

### BRIEF DESCRIPTION OF THE DRAWINGS

FIG. 1 illustrates an exemplary angled portion of a pipe;

FIG. 2 illustrates a perspective view of a preconfigured vapor barrier element in accordance with an embodiment of the present disclosure;

FIG. 3 illustrates a front view of the preconfigured vapor barrier element of FIG. 2 in accordance with an embodiment of the present disclosure;

FIG. 4 illustrates the perspective view of the preconfigured vapor barrier element of FIG. 2 with a protective layer partially removed in accordance with an embodiment of the present disclosure;

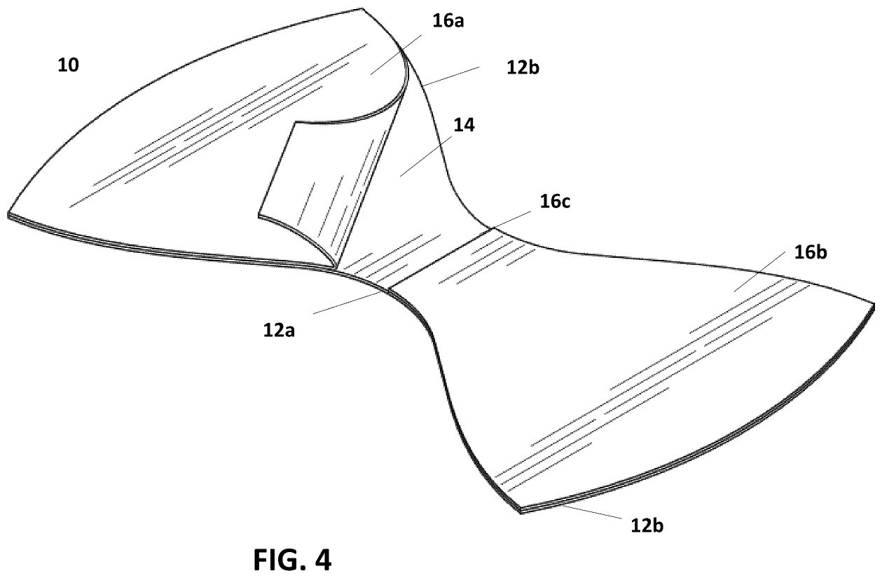

FIG. 5 illustrates a bottom view of the preconfigured vapor barrier element of FIG. 2 in accordance with an embodiment of the present disclosure; and

FIG. 6 illustrates an exemplary flow chart of a method of applying the preconfigured vapor barrier element to a bent insulated pipe in accordance with an embodiment of the present disclosure.

### DESCRIPTION OF THE EMBODIMENTS

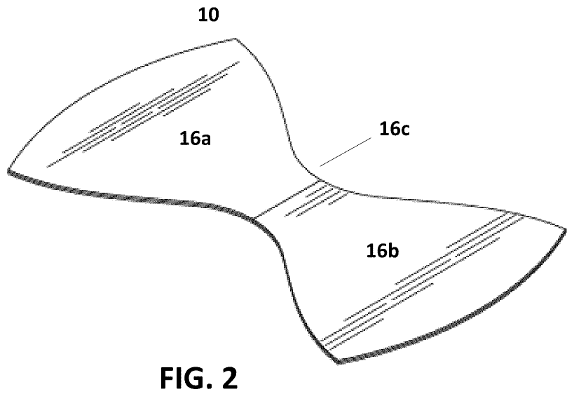

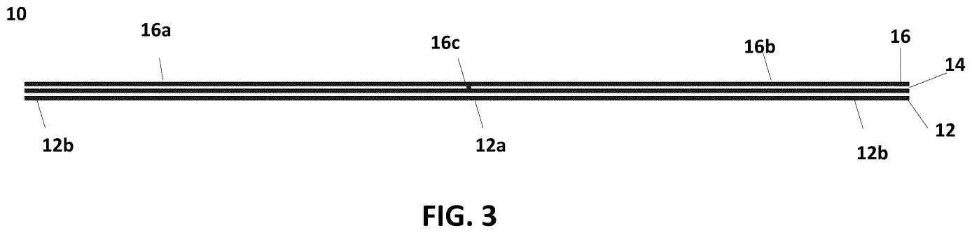

FIG. 2 illustrates an exemplary preconfigured vapor barrier element 10 in accordance with an embodiment of the present application. In embodiments, the vapor barrier element 10 may include multiple layers, as generally indicated in FIG. 3. In embodiments, a vapor barrier layer 12, which faces outward when applied to an insulated pipe fitting is made of a vapor barrier material. In embodiments, the vapor barrier material may be a water-resistant material. In embodiments, the vapor barrier material reduces the rate at which water vapor passes through it. In embodiments, the vapor barrier material may be or may include polyester film, aluminum foil and another layer of polyester film. In embodiments, the vapor barrier material may be or include plastic industrial saran, polyethylene, rubberized asphalt, extruded polystyrene, foil-faced foam, membranes, paper-backed aluminum, elastomeric coatings, asphalt covered kraft paper, metallized films, ply-aluminum foil-poly sheet, or homogenous film such as poly-vinylidene chloride (PVdC) film. In embodiments, the vapor barrier material has a permeance of less than 0.2 perm. Further, in embodiments, the vapor barrier material should be flexible to allow for expansion and contraction of the pipes. In embodiments, the permeance characteristics of the vapor barrier material may vary and may be selected depending on the application for the vapor barrier element 10, for example, the temperature of the fluid in the pipe. In embodiments, cold piping, which may be used in chilled water systems, cold water plumbing, rain leaders and refrigerant piping may require insulation and a vapor barrier to prevent condensation that will render the insulation useless and provide a negative R value. In embodiments, not providing the vapor barrier may result in inefficiency in the insulation system and may result in mold.

In embodiments, the vapor barrier element 10 may include an adhesive layer 14 that may be provided on a surface of the vapor barrier layer 12 that faces the insulated pipe. In embodiments, the adhesive layer 14 may be a substrate with an adhesive material provided on it or may be implemented by applying adhesive material directly to the surface of the vapor barrier layer 12. In embodiments, the adhesive may be a cold weather acrylic adhesive.

In embodiments, a release layer 16 may cover the adhesive layer 14 to prevent the vapor barrier element 10 from adhering to undesired surfaces. In embodiments, the release layer 16 includes a first part 16a and a second part 16b. In embodiments, the two parts 16a, 16b may be separated at a seam 16c. In embodiments, the seam 16c may be a perforated seam allowing the first part and second part 16a, 16b to be separately removed from the vapor barrier element 10. In embodiments, the seam 16c may simply be a disconnection between edges of the parts 16a, 16b that allows for the parts to be separately removed from the element 10. In embodiments, the release layer may be any suitable material that allows for easy removal. In embodiments, the edges of the first part and second part 16a, 16b may overlap slightly and not be connected.

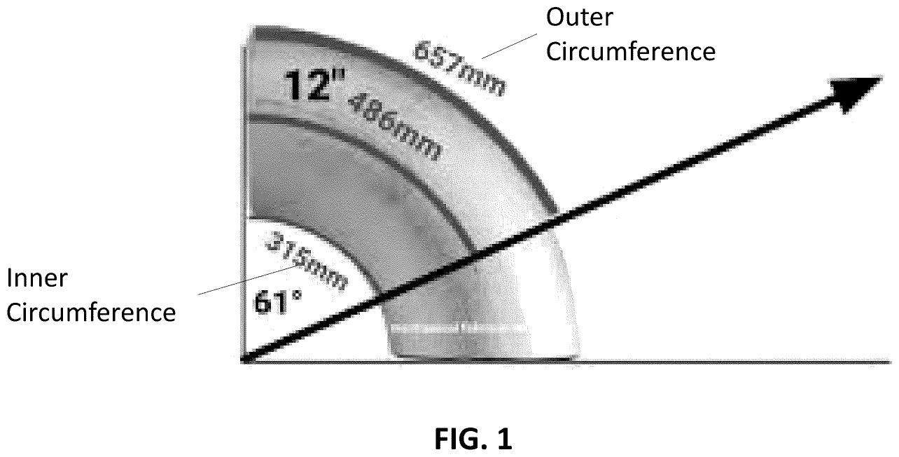

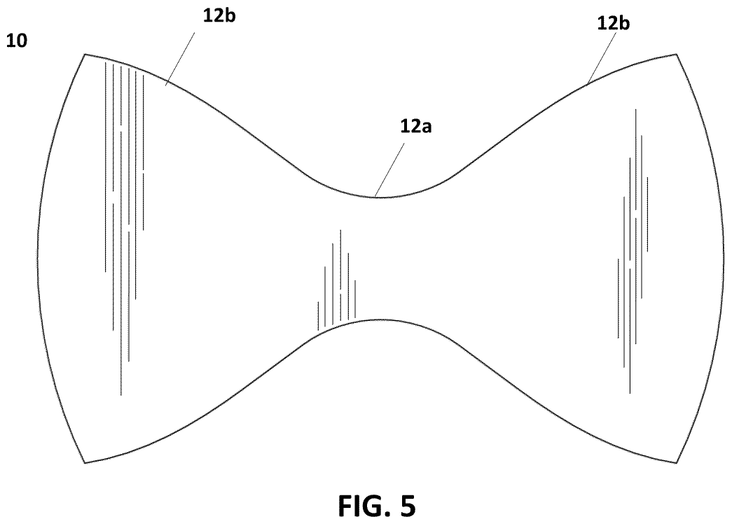

In embodiments, the vapor barrier layer 12 has an hour-glass shape (see FIG. 5, for example) including a narrow connecting portion 12a connecting the first and second end parts 12b, which may have a tear drop shape, as can generally be seen in FIG. 5. In embodiments, the first end part and second end part 12b have the same shape and the connecting portion 12a is narrower than the first and second end parts. In embodiments, the ratio of the width of the end parts 12b to the connecting portion 12a is about 3:1. In embodiments, the ratio of the width of the end parts 12b to the connecting portion 12a is about 3.2:1. In embodiments, in use, the narrow connecting portion 12a may be applied to an inner portion of the angled insulated pipe which has a shorter length, as can be seen in FIG. 1, than the outer portion of the angled insulated pipe. In embodiments, the first and the second end parts 12b wrap around the angled portion of pipe insulation and include at least some overlap such that the entire outer curved portion of the insulated pipe is covered. In embodiments, the unique shape of the vapor barrier layer 12 allows for full coverage of the angled insulated pipe portion with minimal waste and simple and efficient application. As indicated in FIG. 5, the seam 16c in the release layer corresponds to the connection portion 12a of the barrier layer.

In embodiments, the size of the vapor barrier element 10 may be varied depending on the specific joint or bend that it will be used for. In embodiments, the barrier element 10 may be larger or smaller than illustrated. In embodiments, the width of the connecting portion 12a and/or the first and second end parts 12b may be varied to ensure a proper fit on the angled portion, fitting or junction of the pipe.

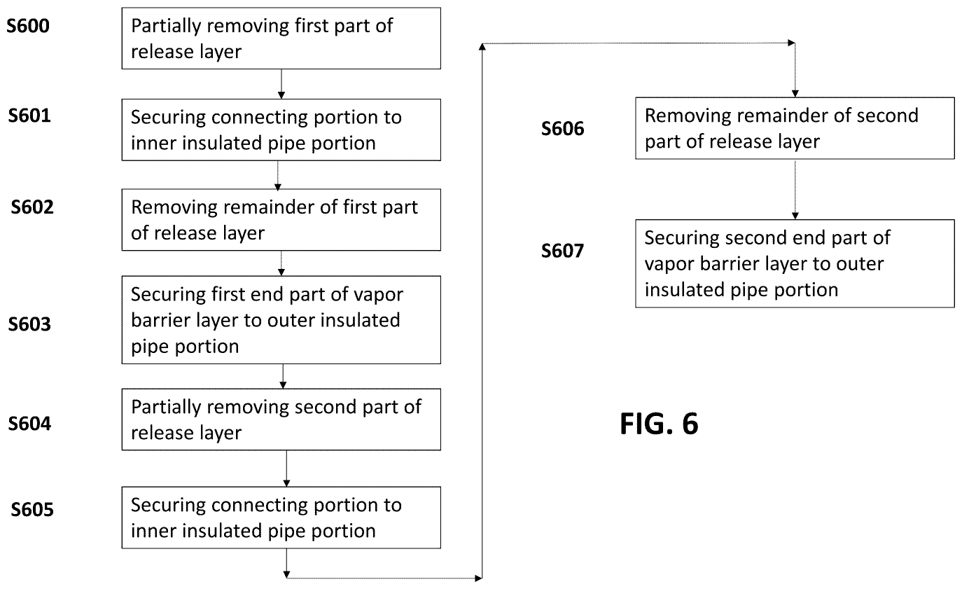

FIG. 6 illustrates an exemplary flow chart for applying the vapor barrier element 10 to a curved insulated pipe portion. In embodiments, in step S600 a user will partially remove one of the first part 16a and second part 16b of the release layer 16 to expose a portion of the adhesive layer 14. In embodiments, at step S601, the exposed first portion of the adhesive layer may be secured to the inner curved portion of the curved portion of the insulated pipe. Then, in step S602, the remainder of the first part 16a or second part 16b of the release layer 16 may be gradually removed to expose more of the adhesive layer 14. At step S603, the additional portion of the adhesive layer is secured to the insulated pipe such that a first end part 12b of the vapor barrier layer 12 is secured to the outer curve of the curved portion of the insulated pipe. In step S604, the other of the first part 16a and the second part 16b of the release layer 16 is partially released to expose the adhesive layer 14 over the connecting portion 12a of the vapor barrier layer 12. At step S605, the adhesive layer over the connecting portion 12a of the vapor barrier layer is secured to the inner curved portion of the insulated pipe. At step S606, the remainder of the first part 16a or second part 16b of the release layer 16 is gradually removed to expose the remainder of the adhesive layer 14 provided over the second end part 12b of the vapor barrier layer 12. In step 607, the second end part 12b of the vapor barrier layer 12 is secured to the outer curve of the curved portion of insulated pipe. As noted above, the ends of the first and second end parts 12b may overlap to ensure that the entire insulated pipe is covered by the vapor barrier element 10.

In embodiments, the two piece nature of the release layer 16 is an important feature. As a practical matter, the curved insulated pipe sections present a unique geometry that is difficult to reliably cover. The two piece nature of the release layer 16 simplifies application of the vapor barrier element 10. As noted above, the release layer 16 may be removed gradually and in two separate pieces to ensure that the vapor barrier element 10 is properly secured to the curved insulated pipe as desired while avoiding adhesion to other surfaces. Releasing a portion of the first part 16a or second part 16b over the connecting portion 12a allows for a portion of the adhesive layer to be exposed to secure a portion of the connecting portion to the shorter inner curve of the curved insulated pipe. The rest of the first part 16a (or second part 16b) may then be gradually pulled off to reveal the adhesive layer on the first end part 12b such that the as the adhesive layer is gradually secured to the outer surface of the curved insulated pipe section. Once one end part 12b is secured to the insulated pipe the process can be repeated with the other of the first part 16a and second part 16b to secure the remainder of the connecting portion 12a to the inner curve and gradually secure the other end part 12b to the longer outer portion of the insulated pipe. Using a single piece for the release layer 16 would leave the entire adhesive layer exposed during installation and creates a high risk of adhering to the wrong portions of the insulated pipe and/or of the end parts sticking to each other. The two piece configuration and positioning of the seam 16c in the middle of the connecting portion 12a simplifies installation, prevents unwanted adhesion to other surfaces and ensures a secure and accurate fit even on curved positioned of pipe.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A vapor barrier element comprising:
a vapor barrier layer having an hour-glass shape with a connecting portion connecting a first end part and a second end part;
an adhesive layer provided on an inner surface of the vapor barrier layer; and
a release layer releasably secured to the adhesive layer and including a first part and a second part, the first part and second part covering the adhesive layer such that the first part is separable from the adhesive layer independent of the second part.

2. The vapor barrier element of claim 1, wherein the vapor barrier layer includes polyester film, aluminum foil and another polyester film layer.

3. The vapor barrier element of claim 1, wherein the vapor barrier layer includes at least one of the group consisting of: saran, polyethylene, rubberized asphalt, aluminum foil, extruded polystyrene or a foil-faced foam, membranes, paper-backed aluminum, elastomeric coatings, asphalt covered kraft paper, metallized film, a ply-aluminum foil-poly sheet, and poly-vinylidene chloride.

4. The vapor barrier element of claim 1, wherein the adhesive layer includes a substrate with an adhesive material provided on a surface opposite the vapor barrier layer.

5. The vapor barrier element of claim 1, wherein the adhesive material includes a cold weather acrylic adhesive.

6. The vapor barrier of claim 1, wherein the adhesive layer includes an adhesive material provided on a surface of the vapor barrier layer.

7. The vapor barrier of claim 1, wherein the release layer includes a seam provided between the first part and the second part and positioned over the connecting portion of the vapor barrier layer.

8. The vapor barrier of claim 1, wherein the connecting portion is narrower in width than the first end part and the second end part of the vapor barrier layer.

9. A method of applying a vapor barrier element to a curved portion of an insulated pipe including an inner curved portion and an outer curved portion comprising steps of:
partially releasing a first part of a release layer of the vapor barrier element to expose a first portion of an adhesive layer of the vapor barrier element provided over a connecting portion of a vapor barrier layer of the vapor barrier element;
securing the exposed first portion of the adhesive layer and the connecting portion to the inner curved portion of the curved portion of the insulated pipe;
gradually removing a remainder of the first part of the release layer to expose a second portion of the adhesive layer provided over a first end part of the vapor barrier layer;
securing the second portion of the adhesive layer and the second end part of the vapor barrier layer to the insulated pipe such that the first end part is secured to the outer curve of the curved portion of insulated pipe;
partially releasing a second part of the release layer of the vapor barrier element to expose a third portion of the adhesive layer over the connection portion of the vapor barrier layer;
securing the exposed third portion of the adhesive layer to the inner curved portion of the curved portion of insulated pipe;
gradually removing a remainder of the second part of the release layer to expose a fourth portion of the adhesive layer provided over a second end part of the vapor barrier layer; and
securing the fourth portion of the adhesive layer and the second end part of the vapor barrier layer to the insulated pipe such that the second end part of the vapor barrier layer is secured to the outer curve of the curved portion of insulated pipe.

10. The method of claim 9, wherein the connecting portion, first end part and second end part of the vapor barrier layer form an hour-glass shape.

11. The method of claim 9, wherein the release layer includes a seam separating the first part and the second part.

12. The method of claim 9, wherein the seam is positioned over the connecting portion of the vapor barrier layer.

13. The method of claim 9, wherein the vapor barrier layer includes polyester film, aluminum foil and another polyester film layer.

14. The method of claim 9, wherein the vapor barrier layer includes at least one of the group consisting of: saran, polyethylene, rubberized asphalt, aluminum foil, extruded polystyrene or a foil-faced foam, membranes, paper-backed aluminum, elastomeric coatings, asphalt covered kraft paper, metallized film, a ply-aluminum foil-poly sheet, and poly-vinylidene chloride.

15. The method of claim 9, wherein the adhesive layer includes a substrate with an adhesive material provided on a surface opposite the vapor barrier layer.

16. The method of claim 15, wherein the adhesive material includes a cold weather acrylic adhesive.

17. The method of claim 9, wherein the adhesive layer includes an adhesive material provided on a surface of the vapor barrier layer.
